(19) United States
(12) Patent Application Publication
(10) Pub. No.: US 2005/0282121 A1
(43) Pub. Date: Dec. 22, 2005

(54) Foreign language instruction by voice tonality technology

(76) Inventor: Lisa S. Zajur, Midlothian, VA (US)

Correspondence Address: Anthony Claiborne, 849 136th Ave. N.E., Bellevue, WA, 98005, US

(21) Appl. No.: 10/873,986

(22) Filed: Jun. 22, 2004

(51) Int. Cl. G09B 19/06

(52) U.S. Cl. 434/157

(57) ABSTRACT

A method of foreign language education and instruction presents the student with a spoken target language expression in a series of specific contrasting voice tonalities, while at the same time the student is provided with contextually appropriate background sound. The expression to be presented may be a single word, a phrase, a sentence or a short narrative or monologue. The background sound may be music selected as appropriate to connote the nationality of the target language and, if possible, the context or meaning of the target language expression. In an educational session, while the background music is presented, a single narrator presents a target language expression by repeating it several times, each time with a different voice tonality connoting a distinct emotional state or mood on the part of the narrator. In preferred embodiments, four voice tonalities are used in succession: professional, friendly, questioning and sexy tones. An educational session comprises the presentation of one or more expressions by one or more narrators, accompanied by appropriate background sound.

### BACKGROUND OF THE INVENTION

1. Field of the Invention

This invention relates to methods of foreign language education and instruction. More particularly, this invention relates to an improvement in such methods, in which a spoken target language expression is systematically repeated in a series of iterations in specific contrasting voice tonalities, while providing contextually appropriate background sound that serves to relax the pupil and focus learning concentration.

2. Description of the Related Art

Sound recordings have been used for providing instruction in vocal arts since the dawn of popularly available recorded sound reproduction technology. For example, U.S. Pat. No. 1,229,142 to Saenger describes an educational appliance for assisting in instruction in voice culture through the aid of a phonograph, whereby “a fixed, invariable and unchanging standard of practice may be established and availed of at any time and place.” U.S. Pat. No. 2,082,261 to Runyan describes a phonograph repeating, charting, and projecting mechanism for selectively reproducing and automatically repeating sound record material to facilitate the study of subjects such as foreign languages.

It has long been recognized that incorporating background sounds that are substantively related to the subject matter of the instruction into an educational sound recording can enhance the interest of the listener and the learning effect of the educational sound recording. For example, U.S. Pat. No. 4,354,841 to Meeder claims the use of at least two series of associated recorded phrases played in conjunction with continuous background sounds, the subject matter of which is substantively related to the subject matter of the recorded phrases The association by the listener of each series of phrases with the background sounds leads the listener to associate the phrases with each other, thus enhancing the learning effect obtainable with the recording.

It has also been recognized that the intonation of the presentation of spoken educational material is one of several parameters which, if varied, enhances the learning effect of presented recorded material. In this regard, an article by G. K. Lozanov (Lozanov, G. K. Suggestology. Science and Art. Sofia. 1971) is cited by Diament et al. in U.S. Pat. No. 4,012,848 directed to an audio-visual teaching machine for speedy training.

More recently, for example in U.S. Pat. No. 4,759,720 to Niemoller, it has been recognized that, in educational sound recordings, a combination of background music and intonation deviating from the normal idiomatic form may both secure the relaxation of the pupil and increase the pupil's concentration.

What has been lacking in the prior art, and what is needed, is a systematic method of enhancing the educational effectiveness of educational presentations by varying voice tonality of spoken expressions while simultaneously presenting substantively related background sound.

It is an object of the present invention to enhance the educational effectiveness of automatically reproduced foreign language instruction by varying the voice tonality of repeated spoken instructional expressions.

It is a further object of this invention to provide a systematic and effective variation in the emotive voice tonality of repeated spoken instructional expressions to enhance the educational effectiveness of automatically reproduced foreign language instruction.

It is a further object of this invention to enhance the effectiveness of automatically reproduced foreign language instruction employing varying voice tonality by providing contextually appropriate background sound such as music.

### BRIEF DESCRIPTION OF THE INVENTION

The present invention is a method of foreign language education and instruction, in which a spoken target language expression is presented to the student in a series of specific contrasting voice tonalities, while at the same time the student is provided with contextually appropriate background sound, such as music. The expression to be presented may be a single word, a phrase, a sentence or a short narrative or monologue. In preferred embodiments, the background sound is music selected as appropriate to connote the nationality or culture associated with the target language and, if possible, the context or meaning of the target language expression. In an educational session, while the background sound is presented, a single narrator repeats a target language expression several times, each time with a different and distinct voice tonality. Preferably, each repetition connotes a distinct emotional state or mood on the part of the narrator. In preferred embodiments, four contrasting emotive voice tonalities are used in succession: professional, friendly, questioning and sexy tones. The present invention may be implemented in any manner enabling the production of such aural instruction for a pupil, including language instruction sound recordings as well as programmatic or algorithmic production of sound according to these teachings.

### BRIEF DESCRIPTION OF THE DRAWINGS

Other objects, advantages, features and characteristics of the present invention, as well as methods, operation and function of related elements of structure, and the combination of parts and economies of deployment, will become apparent upon consideration of the following description and claims with reference to the accompanying drawing, which forms a part of this specification, wherein:

FIG. 1 is a diagrammatic representation of an embodiment of the present invention.

### DETAILED DESCRIPTION OF THE PREFERRED EMBODIMENTS

The present invention is directed to the aural presentation of language instructional material to students. It combines background sound with expressions voiced in systematically varied voice tonality to enhance student learning.

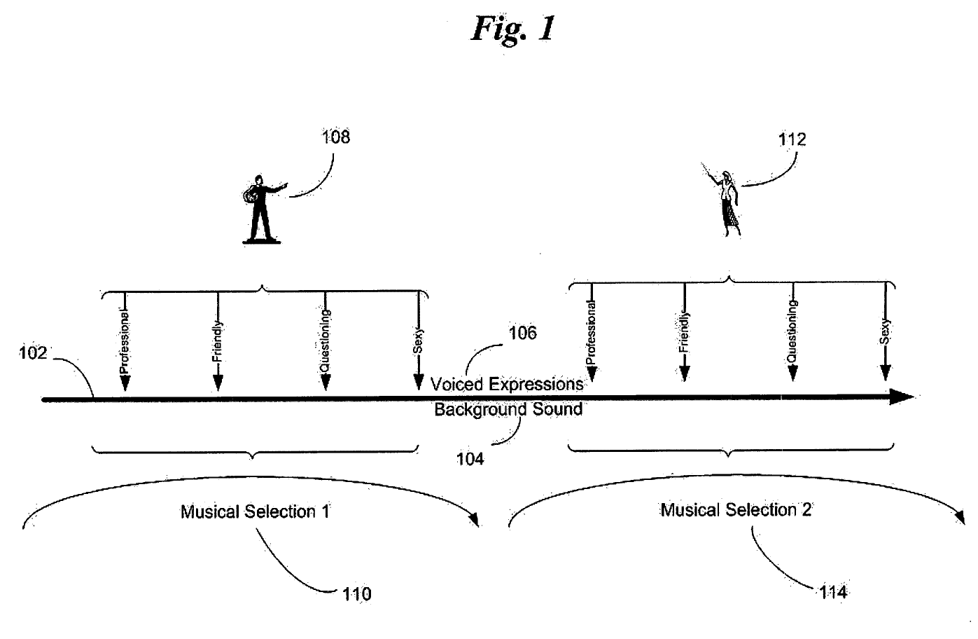

Turning to FIG. 1, composite audio session 102 is comprised of a background sound track 104 and a voiced expressions track 106. In the reproduction of composite audio 102, tracks 104 and 106 may be reproduced for the listener as stereophonically directionally distinct sources, such as left and right headphone respectively. As will readily be understood by those in the art, however, many alternatives are possible for the reproduction of composite audio 102. For example, background sound track 104 may itself comprise stereophonic sound which is reproduced stereophonically for the listener, while voiced expression track 106 may comprise monaural sound which may, in turn, be reproduced for the listener as either a directionally distinct source or as a monaural source distributed over the listener's speakers or headphones. In any case, the two tracks are reproduced simultaneously for the pupil listener.

The voiced expressions track comprises a sequence of presentations of a number of expressions that are the subject of the instruction. The presentation of an expression, in turn, comprises a sequence of voiced utterances of the expression, each utterance with a different voice tonality.

The depicted composite audio portrays a session 102 with two presentations. For each presentation, a single narrator 108, 112, voices the expression a fixed number of times, each time in a different voice tonality according to a fixed sequence. In the depicted embodiment, the sequence of successive tonalities are: Professional; Friendly; Questioning; and Sexy, which is a preferred sequence of tonalities. However, as will be clear to persons of skill in the art, other sequences of distinct tonalities may be effectively employed in accordance with teachings of the present invention.

The number of distinct tonalities used in sequence for each presentation is preferably more than two, to provide heuristically effective contrast. Also preferred is seven or fewer distinct tonalities in sequence, for two principal reasons. First, as the number of required distinctive tonalities increases, it becomes increasingly difficult for the narrator consistently to produce distinctive iterations conforming to each required tonality. Second, the heuristic effectiveness of the present invention is optimized when the pupil recognizes and anticipates the tonalities in which the expression is to be voiced. Too great a number of tonalities in a sequence frustrates such recognition and anticipation. In any case, what is required by the present invention is that the same sequence of tonalities be used in each presentation of each expression.

The narrator 108, 112 may be the same person throughout a session voicing all the presentations. Alternatively, as depicted, different narrators 108, 112 may be used for different presentations. However, in accordance with the teaching of this invention, the narrator for each sequence of tonalities for a given presentation is preferably the same person, so that the principal discernable difference between voiced iterations of the expression in a presentation is the tonality with which it is voiced.

The sequence of presentations in a session may typically comprise a number of different expressions. However, it is also consistent with the teachings of the present invention that there may be several presentations of the same expression in a single session. In the illustrated session, for example, it may be heuristically beneficial for female speaker 112 to voice a presentation sequence of the same expression that was earlier voiced in a presentation sequence by male speaker 108.

Embodiments of the present invention may require response on the part of the pupil after presentations. For example, some embodiments may request the pupil to repeat the expression aloud after the presentation of the voice tonality sequence for the expression. Other embodiments may require the pupil to designate the meaning of the expression voiced in a presentation sequence, such as by choosing a definition of the expression in the pupil's native language from a list, or by selecting a graphic depiction of the meaning of the expression. As will be clear to those of skill in the art, the method taught by the present invention may be adapted to the presentation requirements of virtually any system for the auditory instruction of foreign language.

Simultaneously with the reproduction of the voiced expression track 106, session 102 comprises reproduction of a background sound track 104. The purpose of sound track 104 is principally to provide context for the presentations of expressions while securing the relaxation of the pupil, placing him or her in a receptive frame of mind. Accordingly, background sound 104 may comprise selections of music 110, 114 which connote the culture or national origin of the target language but are not overly intrusive. Lower volume instrumental renditions of appropriate ethnic music may be effectively employed for this purpose. Alternatively, as will be clear to those of skill in the art, background sound track 104 may comprise an appropriately chosen environmental recording, reflecting a specific context for expressions presented in session 102.

As depicted, there are two distinct musical selections, 110 and 114 for background sound 104, each corresponding to a presentation 108, 112 of an expression. However, as will be clear to those of skill in the art, the present invention does not require distinct selections in background sound 104 corresponding one-to-one with presentations 108, 112 in the voiced expression track 106, and in fact many alternatives are possible. For example, a single selection in background sound 104 may be employed for all presentations 108, 112 in a session 102. Alternatively, a single selection in background sound 104 may be presented simultaneously with a plurality but less than all of the voiced presentations in a session 102, while other selections in background sound 104 are presented with other voiced presentations. In any case, what is required is that voiced expressions track 106 be substantially accompanied by background sound 104 in keeping with the present invention.

Embodiments of the present invention may implement session 102 as a sound recording, such as a cassette tape or compact disc (CD) for replay by the pupil according to conventions employed in the use of recorded instructional materials. Narrators 108, 112 may comprise human speakers, whose voiced presentation sequences may be recorded on the sound recording. Alternatively, narrators 108, 112 may present live voiced expressions directly to pupils or through narrowcast or broadcast means as are known to those of skill in the art. As a further alternative, voiced expressions 106 may be created by speech synthesizer with suitable synthetic emotive speech. Synthetic voiced expressions may be recorded in sound recordings or broadcast as described above, or, in the alternative, synthetic voiced expressions may be generated algorithmically and presented to the pupil under programmatic control. In the latter case, the present invention may be implemented as a stand-alone software package for use on a pupil's desktop computer, or it may be implemented in a network to which the pupil interfaces, according to any number of client-server or peer-to-peer arrangements well known to those of skill in the art.

In a similar vein, background sound 104 may be recorded or broadcast along with recorded or broadcast voiced expressions. Alternatively, background sound 104 may be synthesized from data, such as by the Musical Instrument Digital Interface (MIDI) specification and protocol, which may be implemented either in the desktop or the network environment.

### CONCLUSIONS, RAMIFICATIONS, AND SCOPE

Accordingly, it can be seen that the invention described herein provides an improved method of instruction in a target language, featuring the iterative presentation of expressions with systematically varied voice tonality and educationally enhancing background sound.

Although the detailed descriptions above contain many specifics, these should not be construed as limiting the scope of the invention but as merely providing illustrations of some of the presently preferred embodiments of this invention. Various other embodiments and ramifications are possible within its scope, a number of which are discussed in general terms above. It is intended that the scope of the present invention encompass all means known to those of skill in the art for creating voiced expressions and background sounds and presenting them to the pupil according to its teachings.

While the invention has been described with a certain degree of particularity, it should be recognized that elements thereof may be altered by persons skilled in the art without departing from the spirit and scope of the invention. Accordingly, the present invention is not intended to be limited to the specific forms set forth herein, but on the contrary, it is intended to cover such alternatives, modifications and equivalents as can be reasonably included within the scope of the invention. The invention is limited only by the following claims and their equivalents.

1. A method of education and instruction in a target language, comprising:
presenting a composite audio session to a pupil, the session comprising:
a voiced expressions track, comprising at least one presentation of an expression, the presentation comprising a specified sequence of voiced iterations of the expression in the target language, each iteration voiced in a distinct, specified tone; and
a background sound track, the subject matter of which is substantively related to at least one of the target language and the meaning of the expression.

2. A method of target language education and instruction according to claim 1, wherein the voiced tone in each iteration in a sequence conveys a distinct, specified emotion.

3. A method of target language education and instruction according to claim 2, wherein the sequence of voiced iterations is presented in tones that are sequentially professional, friendly, questioning and sexy.

4. A method of target language education and instruction according to claim 1, wherein the number of iterations in each sequence is more than two and less than seven.

5. A method of target language education and instruction according to claim 1, wherein the background sound track is comprised of one or more musical selections.

6. A sound recording for target language instruction, comprising:
a voiced expressions track, comprising at least one presentation of an expression, the presentation comprising a specified sequence of voiced iterations of the expression in the target language, each iteration voiced in a distinct, specified tone; and
a background sound track, the subject matter of which is substantively related to at least one of the target language and the meaning of the expression.

7. A sound recording for target language instruction according to claim 6, wherein the voiced tone in each iteration in a sequence conveys a distinct, specified emotion.

8. A sound recording for target language instruction according to claim 7, wherein the sequence of voiced iterations is presented in tones that are sequentially professional, friendly, questioning and sexy.

9. A sound recording for target language instruction according to claim 6, wherein the number of iterations in each sequence is more than two and less than seven.

10. A sound recording for target language instruction according to claim 6, wherein the background sound track is comprised of one or more musical selections.

11. A computer under software control for the generation of audio instruction in a target language, the audio instruction comprising:
a voiced expressions track, comprising at least one presentation of an expression, the presentation comprising a specified sequence of voiced iterations of the expression in the target language, each iteration voiced in a distinct, specified tone; and
a background sound track, the subject matter of which is substantively related to at least one of the target language and the meaning of the expression.

12. A computer-readable medium for a computer having an executable program stored thereon comprising:
means for causing a computer to present a pupil with audio instruction in a target language, the audio instruction comprising:
a voiced expressions track, comprising at least one presentation of an expression, the presentation comprising a specified sequence of voiced iterations of the expression in the target language, each iteration voiced in a distinct, specified tone; and
a background sound track, the subject matter of which is substantively related to at least one of the target language and the meaning of the expression.

13. A signal embodied in a propagation medium, said signal comprising a set of instructions for a computer, comprising:
means for causing the computer to present a pupil with audio instruction in a target language, the audio instruction comprising:
a voiced expressions track, comprising at least one presentation of an expression, the presentation comprising a specified sequence of voiced iterations of the expression in the target language, each iteration voiced in a distinct, specified tone; and
a background sound track, the subject matter of which is substantively related to at least one of the target language and the meaning of the expression.

14. A sound recording for target language instruction, comprising:
a voiced expressions track, comprising at least one presentation of an expression, the presentation comprising a sequence of voiced iterations of the expression in the target language, the sequence comprising voiced iterations in tones that are sequentially professional, friendly, questioning and sexy; and
a background sound track comprised of at least one musical selection, the subject matter of which is substantively related to at least one of the target language and the meaning of the expression.
